(19) United States
(12) Patent Application Publication
(10) Pub. No.: US 2007/0022433 A1
(43) Pub. Date: Jan. 25, 2007

(54) Disk cartridge

(76) Inventor: Kenji Hashizume, Tokyo (JP)

Correspondence Address: GREENBLUM & BERNSTEIN, P.L.C., 1950 ROLAND CLARKE PLACE, RESTON, VA, 20191, US

(21) Appl. No.: 10/571,090

(22) PCT Filed: Sep. 8, 2004
(86) PCT No.: PCT/JP04/13037

§ 371 Date: Mar. 8, 2006

(30) Foreign Application Priority Data
Sep. 9, 2003 (JP) 2003-316157

(51) Int. Cl. G11B 23/03

(52) U.S. Cl. 720/727

(57) ABSTRACT

A disc-shaped recording medium is housed inside a cartridge body including a lower shell and an upper shell formed so as to be capable of being fitted together. An opening for disc access, which is capable of exposing a region that extends from one outer edge part to another outer edge part on an opposite side of a center hole of the disc-shaped recording medium housed inside the cartridge body, is formed in the lower shell. A reinforcing member formed separately from the upper shell is fixed to an inner surface of the upper shell so as to cross the opening in the lower shell in a state where the lower shell is fitted to the upper shell.

### TECHNICAL FIELD

The present invention relates to a disc cartridge where a disc-shaped recording medium is housed in a cartridge body composed of a lower shell and an upper shell.

### BACKGROUND ART

As one example of this kind of disc cartridge, Japanese Laid-Open Patent Publication No. 2003-115181 discloses a disc recording medium device 10 where an optical disc 11 is housed inside a cartridge case 12 (disc enclosure 16). As shown in FIG. 1 of the publication, the disc recording medium device 10 includes the cartridge case 12 including an upper shell 13, a middle shell 14, and a lower shell 15, the optical disc 11 housed in the disc enclosure 16, and shutter members 18a, 18b disposed between the middle shell 14 and the lower shell 15. In this case, the middle shell 14 functions as a disc tray for carrying the optical disc 11 and is housed in the disc enclosure 16 together with the optical disc 11 so as to be sandwiched between the upper shell 13 and the lower shell 15. Here, if the middle shell 14 is rotated with respect to the upper shell 13 and the lower shell 15 by a recording/reproducing apparatus when the disc recording medium device 10 is loaded into and ejected from the recording/reproducing apparatus, part of an opening 25 in the lower shell 15 is opened and closed. The shutter members 18a, 18b are axially supported by the middle shell 14 and are caused to rotate with respect to the middle shell 14 as the middle shell 14 rotates to act in concert with the middle shell 14 to open and close the opening 25 of the lower shell 15.

On the other hand, the upper shell 13 is formed with an overall shape that resembles a shallow plate and is constructed so as to be capable of being fitted to (i.e., being attached to) the lower shell 15. The lower shell 15, in which the opening 25 that allows disc access to the optical disc 11 inside the cartridge case 12 is formed, is constructed so as to be capable of being fitted to the upper shell 13. In this case, the opening 25 is formed so that an opening 25a for a table and openings 25b, 25b for heads are continuous in a front-rear direction of the cartridge case 12. By doing so, a rectangular region that extends from one outer edge part to another outer edge part on the opposite side of a center hole 11a of the optical disc 11 housed in the cartridge case 12 can be exposed, and by clamping the optical disc 11 via the opening 25a for the table and rotating the optical disc 11, it is possible to record and reproduce data using two optical heads simultaneously via the openings 25b, 25b provided for the heads.

Patent Document 1

Japanese Laid-Open Patent Publication No. 2003-115181 (Pages 6 to 14, FIG. 1)

### DISCLOSURE OF THE INVENTION

### Problem to be Solved by the Invention

By investigating the conventional disc recording medium device 10 described above, the present inventor discovered the following problem. With the disc recording medium device 10, to make it possible to record and reproduce data on the optical disc 11 inside the cartridge case 12 using two optical heads simultaneously, the opening 25 that can expose a rectangular region that extends from one outer edge part to the other outer edge part on the opposite side of the center hole 11a is formed in the lower shell 15. With this type of disc recording medium device 10 (disc cartridge), the cartridge case 12 needs to have a certain degree of rigidity to avoid damage to the cartridge case 12 or the optical disc 11 due to deformation of the cartridge case 12 resulting from an external force applied when the disc recording medium device 10 is placed in a bag and carried or from a force applied during loading in a recording/reproducing apparatus, and to avoid recording/reproducing errors due to deformation (warping) of the cartridge case 12 inside the recording/reproducing apparatus. On the other hand, since the middle shell 14 and the shutter members 18a, 18b are not fixed to either the upper, shell 13 or the lower shell 15, the middle shell 14 and the shutter members 18a, 18b make it difficult to increase the rigidity of the cartridge case 12. Accordingly, at a position that overlaps the opening 25 in the thickness direction of the cartridge case 12, the upper shell 13 is the only member that contributes to the rigidity of the cartridge case 12, and therefore the conventional disc recording medium device 10 is extremely weak with respect to forces that act so as to bend the cartridge case 12. As a result, there is the problem of the risk of damage to the cartridge case 12 itself and/or the optical disc 11 and of recording/reproducing errors being caused.

Here, as one example, it would be conceivable to use a construction where the upper shell 13 is molded using a glass fiber-including resin or the like to increase the rigidity of the upper shell 13 as a single member and in turn the rigidity of the entire cartridge case 12. However, when such construction is used, since glass fiber-including resin and the like are not transparent, the optical disc 11 inside the cartridge case 12 is no longer visible through the upper shell 13. This makes the cartridge case 12 less attractive and limits the designs that can be used for the cartridge case 12 to an extremely narrow range (designs where the optical disc 11 inside the cartridge case 12 is not visible). It would also be conceivable to increase the rigidity of the upper shell 13 as a single member and in turn the rigidity of the entire cartridge case 12 by using a construction where the upper shell 13 is made sufficiently thick. However, when such construction is used, since the overall thickness of the cartridge case 12 becomes thicker by the increase in thickness of the upper shell 13, there is the risk that it will no longer be possible to satisfy the standards concerning size that are set for the disc recording medium device 10.

The present invention was conceived in view of the problem described above and it is a principal object of the present invention to supply a disc cartridge that can expose a region that extends from one outer edge part of a disc-shaped recording medium to another outer edge part on the opposite side of a center hole and can also avoid damage to a cartridge body and the disc-shaped recording medium and recording/reproducing errors due to a force applied to the cartridge body.

### Means For Solving The Problem

In a disc cartridge according to the present invention, a disc-shaped recording medium is housed in a cartridge body including a lower shell and an upper shell formed so as to be capable of being fitted together, wherein a disc access opening, which is capable of exposing a region that extends from one outer edge part to another outer edge part on an opposite side of a center hole of the disc-shaped recording medium housed inside the cartridge body, is formed in the lower shell, and a reinforcing member formed separately to the upper shell is fixed to an inner surface of the upper shell so as to cross the disc access opening in the lower shell in a state where the lower shell is fitted to the upper shell. Here, it is possible to use a variety of methods as the method of fixing the reinforcing member to the upper shell, such as a method that uses adhesive, a method that fixes the reinforcing member by melting welding ribs formed on the upper shell using an ultrasonic welding device, and a method where the reinforcing member is fixed by engaging engagement hooks formed on the upper shell.

Here, the reinforcing member may be formed in an annular shape with an inner diameter that is larger than a diameter of the disc-shaped recording medium.

Also, the reinforcing member may be formed of one of fiber-reinforced resin and metal.

### Effect of the Invention

According to the disc cartridge according to the present invention, by fixing the reinforcing member formed separately to the upper shell to the inner surface of the upper shell so as to cross the disc access opening in the lower shell in a state where the lower shell is fitted to the upper shell, it is possible to provide a disc cartridge with a cartridge body that has high rigidity to adequately avoid damage to the cartridge body itself and the disc-shaped recording medium and the occurrence of recording/reproducing errors when an external force is applied (when the cartridge body is bent, for example), while making it possible to carry out recording and reproducing on the disc-shaped recording medium using two optical heads simultaneously. Here, by using a construction where the reinforcing member formed separately to the upper shell is fixed to the inner surface of the upper shell, it is possible to form the upper shell using a transparent resin material, for example, and to form the reinforcing member out of a highly rigid member that resists bending and the like and fix the reinforcing member to the upper shell, and therefore it is possible to use a variety of designs where the disc-shaped recording medium is kept sufficiently visible through the upper shell while increasing the rigidity of the cartridge body.

Also, according to the disc cartridge according to the present invention, by using a reinforcing member formed in an annular shape where the inner diameter is larger than the diameter of the disc-shaped recording medium, it is possible to increase the rigidity while keeping the disc-shaped recording medium favorably visible through the upper shell and without making the appearance less attractive.

In addition, according to the disc cartridge according to the present invention, by forming the reinforcing member of one of fiber-reinforced resin and metal, unlike a construction where rigidity is increased by molding the upper shell itself from a glass fiber-including resin or the like, it is possible to increase the rigidity without the disc-shaped recording medium becoming less visible through the upper shell and it is possible to use a variety of designs and thereby make the cartridge body more attractive. Also, unlike a construction that increases the rigidity of the entire cartridge body by making the upper shell thicker to increase the rigidity of the upper shell as a single body, it is possible to provide the disc cartridge including the cartridge body that has sufficient rigidity to avoid damage to the cartridge body itself and the disc-shaped recording medium and recording/reproducing errors without making the overall thickness of the cartridge body much thicker (i.e., while satisfying the standards concerning size that are set for the disc cartridge).

### BRIEF DESCRIPTION OF THE DRAWINGS

FIG. 1 is a perspective view showing the appearance of a disc cartridge 1.

FIG. 2 is a cross-sectional view of the disc cartridge 1.

FIG. 3 is a plan view of a lower shell 3 of a cartridge body 2 looking from an inner surface side thereof.

FIG. 4 is a plan view of an upper shell 4 of the cartridge body 2 looking from an inner surface side thereof.

FIG. 5 is a plan view of an upper shell 4 (a plan view of the cartridge body 2) in a state where a reinforcing member 7 has been attached to the upper shell 4, when looking from an inner surface side thereof.

FIG. 6 is a perspective view showing the appearance of the reinforcing member 7.

FIG. 7 is a plan view of a disc tray 5 looking from the lower shell 3 side.

FIG. 8 is a plan view of shutter members 6 looking from the lower shell 3 side.

FIG. 9 is a plan view of the upper shell 4 to which reinforcing members 7A, 7A (or a reinforcing member 7B) have been fixed looking from an inner surface side thereof.

FIG. 10 is a perspective view showing the appearance of a disc cartridge 1B.

### BEST MODE FOR CARRYING OUT THE INVENTION

Preferred embodiments of a disc cartridge according to the present invention will now be described with reference to the attached drawings.

First, the construction of a disc cartridge 1 will be described with reference to the drawings.

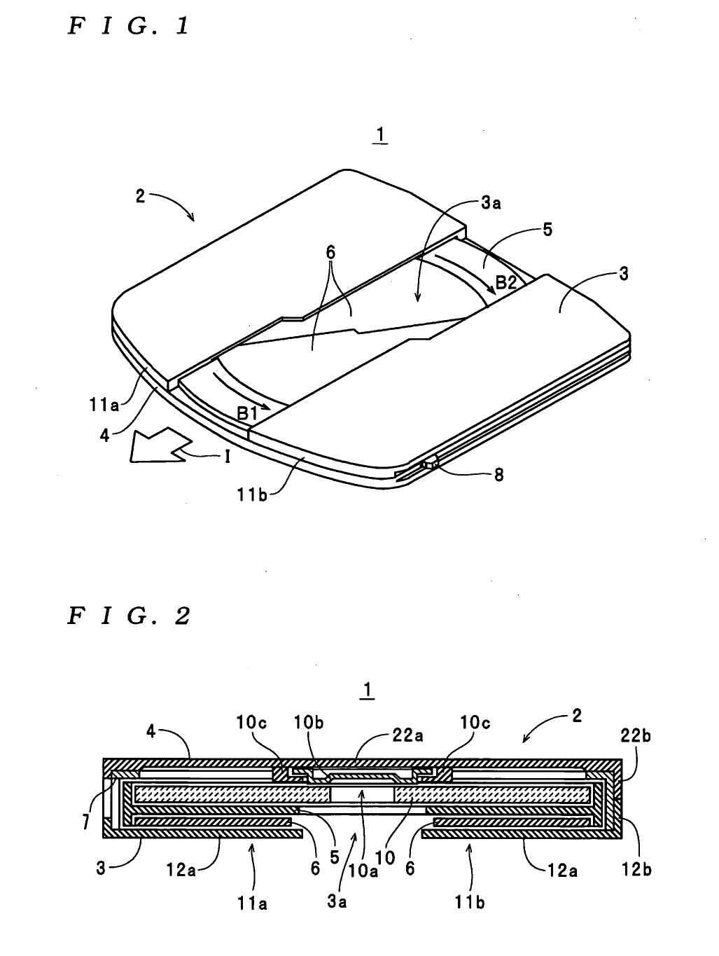

The disc cartridge 1 shown in FIGS. 1 and 2 is a cartridge-type information recording medium constructed so that recording and reproducing of various types of data are possible, includes a cartridge body 2, a disc tray 5, and shutter members 6, and can house an optical disc 10. Note that in FIG. 2, for ease of understanding the present invention, sizes in the thickness direction have been exaggerated. In this case, as one example, the optical disc 10 is a single-sided rewritable disc-shaped recording medium, and as shown in FIG. 2, a center hole 10a with a diameter of around 15 mm is formed in a central part thereof for clamping to a recording/reproducing apparatus. As described later, the optical disc 10 is clamped to the recording/reproducing apparatus by the recording/reproducing apparatus pulling a disc-shaped clamping plate 10b attached to an upper shell 4 of the cartridge body 2 toward a lower shell 3. On the other hand, as shown in FIGS. 1 and 2, the cartridge body 2 includes the lower shell 3 and the upper shell 4 that are formed so as to be capable of being fitted together.

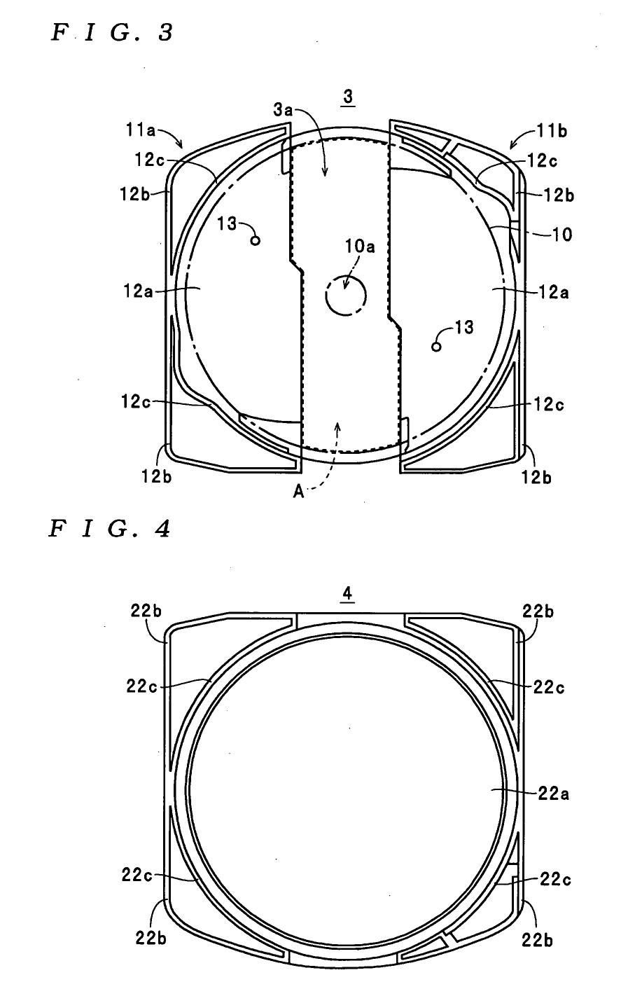

As shown in FIG. 3, the lower shell 3 includes the lower shell bodies 11a and 11b and as one example is manufactured by injection molding using polycarbonate (or ABS resin or the like). More specifically, the lower shell 3 (the lower shell bodies 11a and 11b) includes base plates 12a, side walls 12b that are erected at outer edge parts of the base plates 12a and construct side surface parts of the cartridge body 2, and partition walls 12c that form a disc enclosure inside the cartridge body 2. The lower shell 3 is constructed so that in a state where the lower shell 3 is fitted to the upper shell 4 (a state where the lower shell 3 is integrated with the upper shell 4), an opening 3a corresponding to a “disc access opening” for the present invention is formed between the base plates 12a, 12a of both lower shell bodies 11a and 11b. Here, the opening 3a is a hole that makes disc access (clamping by the recording/reproducing apparatus and irradiation with a laser beam via an optical head) to the optical disc 10 inside the cartridge body 2 possible during the recording and reproducing of data onto and from the optical disc 10, with the opening 3a being formed with a shape and size that can expose a rectangular region A that extends from one outer edge part of the optical disc 10 to another outer edge part on the opposite side of the center hole 10a. According to this construction, the disc cartridge 1 makes it possible to record and reproduce data onto and from the optical disc 10 using two optical heads simultaneously. Convex parts 13 that are respectively erected on the base plates 12a of the lower shell bodies 11a and 11b are inserted into slits 52 (see FIG. 8) of the shutter members 6 and as described later, cause the shutter members 6 to slide when the disc tray 5 rotates.

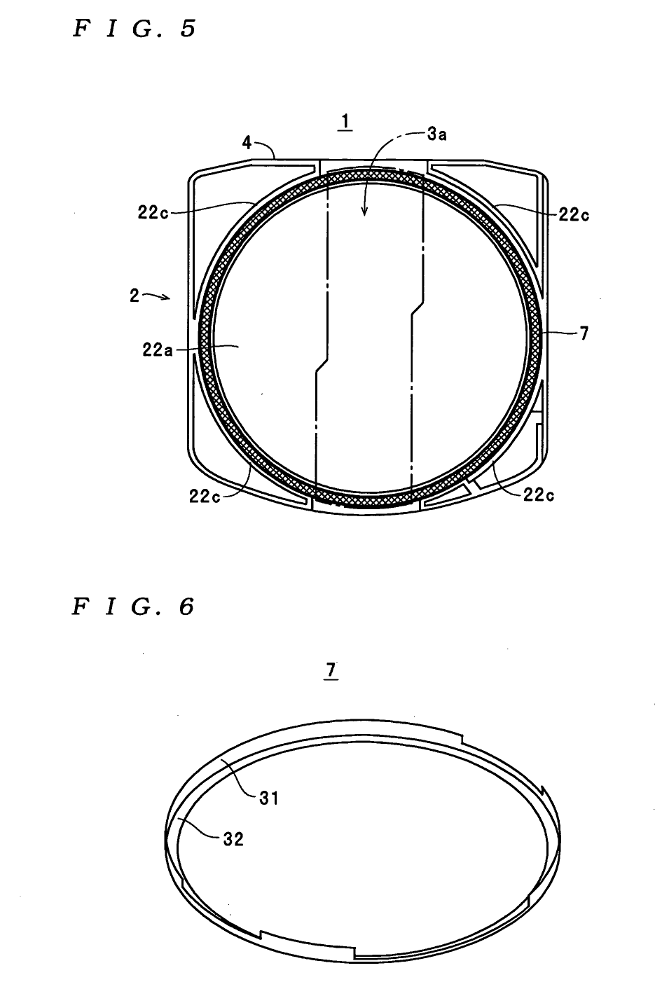

As shown in FIG. 4, the upper shell 4 includes a top plate 22a, side walls 22b that are erected on outer edge parts of the top plate 22a and together with the side walls 12a of the lower shell 3 compose the side surface parts of the cartridge body 2, and partition walls 22c that together with the partition walls 12c of the lower shell 3 form the disc enclosure inside the cartridge body 2. As one example, the upper shell 4 is injection molded using polycarbonate that is transparent. Also, as shown in FIG. 5, in the disc cartridge 1, a reinforcing member 7 is fixed by adhesive, for example, inside the partition wall 22c on the top plate 22a of the upper shell 4 (on an inner surface of the upper shell for the present invention). As shown in FIG. 6, the reinforcing member 7 is integrally constructed of a cylindrical part 31 with substantially the same diameter as the circular region (disc enclosure) formed by the partition walls 22c of the upper shell 4 and a brim part 32 formed by bending a lower end of the cylindrical part 31, and uses stainless steel (one example of “metal” for the present invention) with a thickness of around 0.5 mm. In this case, to avoid contact between the reinforcing member 7 and the optical disc 10 inside the cartridge body 2, the brim part 32 of the reinforcing member 7 is set with an inner diameter that is slightly larger than the diameter of the optical disc 10 (i.e., large enough to prevent the optical disc 10 from contacting the brim part 32). By doing so, it is possible to prevent the view of the optical disc 10 through the upper shell 4 from being obstructed in the state where the reinforcing member 7 is fixed to the upper shell 4. Also, as shown in FIG. 2, the clamping plate 10b is attached to the central portion of the upper shell 4 by an annular attaching member 10c. In this case, the clamping plate 10b is rotatable with respect to the upper shell 4 and is attached so as to be slightly movable in a direction toward and away from the top plate 22a.

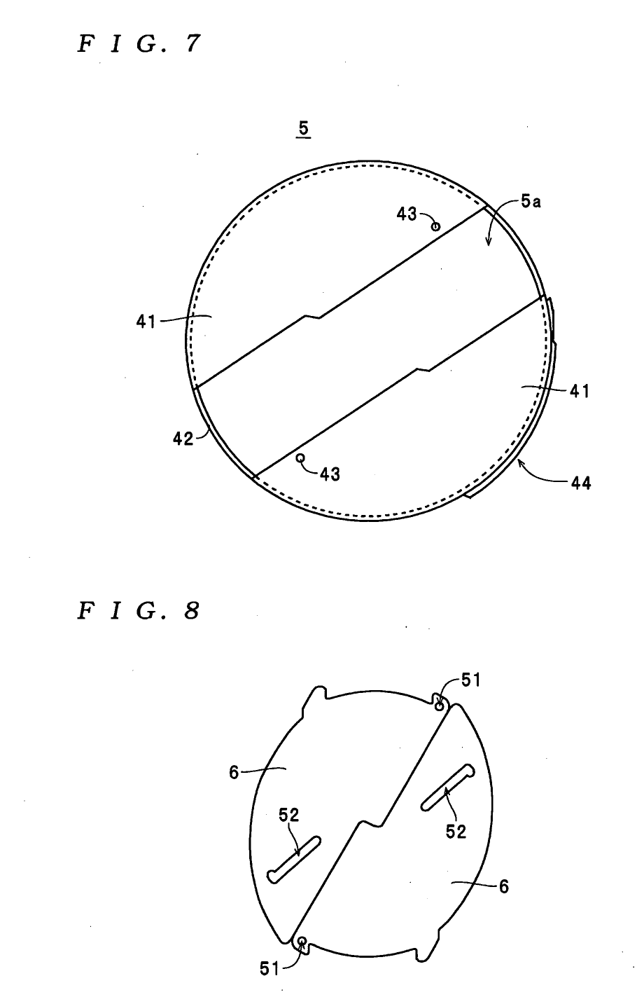

As shown in FIG. 7, the disc tray 5 is formed of disc-shaped base plates 41, in which an opening 5a is formed in substantially the same shape as the opening 3a formed between the lower shell bodies 11a and 11b of the lower shell 3, and a side wall 42 erected on the outer edge parts of the base plates 41. The disc tray 5 is in the shape of a shallow plate upon which the optical disc 10 can be mounted and as shown in FIG. 2, is rotatably housed inside the cartridge body 2 together with the optical disc 10. In this case, as shown in FIG. 7, convex parts 43, 43 for axially supporting the shutter members 6 are erected on lower surfaces of the base plates 41. Also, engaging teeth 44 that can engage a shutter opening/closing means (not shown) of the recording/reproducing apparatus are formed on the side wall 42. It should be noted that the respective teeth of the engaging teeth 44 have been omitted from FIG. 7. Here, rotation of the disc tray 5 with respect to the cartridge body 2 is restricted by a locking member 8 (see FIG. 1). As shown in FIG. 8, holes 51 through which the convex parts 43 of the disc tray 5 can be inserted are formed at one end of each shutter member 6 and the slits 52 through which the convex parts 13 of the lower shell 3 can be inserted are formed at the other ends. As shown in FIG. 2, the shutter members 6 are housed inside the cartridge body 2 so as to be sandwiched between the lower shell 3 and the disc tray 5.

Next, the method of using the disc cartridge 1 will be described with reference to the drawings.

As shown in FIG. 1, when the disc cartridge 1 has been ejected from a recording/reproducing apparatus, the opening 3a of the lower shell 3 is covered by the disc tray 5 and the shutter members 6. On the other hand, when the disc cartridge 1 has been loaded in a recording/reproducing apparatus, the disc cartridge 1 is pulled by the recording/reproducing apparatus into the apparatus in the direction of the arrow I. Note that although the lower shell 3 is shown facing upward in FIG. 1, during actual use, the disc cartridge 1 is loaded into the recording/reproducing apparatus in a state where the upper shell 4 faces upward. The disc tray 5 is rotated by the shutter opening/closing means of the recording/reproducing apparatus, and as a result, the shutter members 6 are caused to rotate with respect to the disc tray 5 to open the opening 3a. More specifically, the shutter opening/closing means contacts the locking member 8 to rotate the locking member 8 with respect to the cartridge body 2 and thereby allow the disc tray 5 to rotate.

Next, when the disc cartridge 1 has been pulled further inside the recording/reproducing apparatus, the shutter opening/closing means engages the engaging teeth 44 of the disc tray 5 and by pulling the disc cartridge 1 further into the apparatus in this state, the disc tray 5 is caused to rotate with respect to the cartridge body 2 in the direction of the arrow B1 shown in FIG. 1. In this state, as the disc tray 5 rotates, the shutter members 6 rotate (slide) about the holes 51 (the convex parts 43 of the disc tray 5). Next, when the disc cartridge 1 is pulled yet further inside the recording/reproducing apparatus, the opening 3a of the lower shell 3 and the opening 5a of the disc tray 5 are caused to overlap one another in the thickness direction of the disc cartridge 1, and the shutter members 6, 6 are rotated and moved from over the opening 5a. By doing so, the region A of the optical disc 10 is exposed, resulting in a state where disc access to the optical disc 10 from outside the cartridge body 2 is possible. After this, the clamping plate 10b is pulled by the recording/reproducing apparatus using magnetic attraction so that a rim part of the center hole 10a is clamped, and irradiation with a laser beam (i.e., the recording and reproducing of data) is carried out via the opening 3a.

On the other hand, when the disc cartridge 1 for which the recording and reproducing of data is complete is ejected from the recording/reproducing apparatus, the shutter opening/closing means of the recording/reproducing apparatus causes the disc tray 5 to rotate in the direction of the arrow B2 shown in FIG. 1 and the shutter members 6 are caused to rotate together with such rotation, so that the disc tray 5 and the shutter members 6, 6 cover the opening 3a. By doing so, the optical disc 10 inside the cartridge body 2 is protected by the cartridge body 2, the disc tray 5, and the shutter members 6, 6.

Also, if the disc cartridge 1 in this state (where the opening 3a is covered) is placed in a bag, for example, and carried, deformation of the cartridge body 2 is prevented by the reinforcing member 7 fixed to the upper shell 4. More specifically, in the disc cartridge 1, as described above the annular reinforcing member 7 formed separately to the upper shell 4 of stainless steel is fixed to the top plate 22a of the upper shell 4. In this case, as shown in FIG. 5, the reinforcing member 7 is fixed to the top plate 22a of the upper shell 4 so as to cross the opening 3a of the lower shell 3 in a state where the lower shell 3 is fitted to the upper shell 4. Accordingly, even though a lower shell 3 composed of separate lower shell bodies 11a and 11b is used, the reinforcing member 7 fixed to the top plate 22a can sufficiently increase the rigidity of the upper shell 4 as a single member, and therefore the rigidity of the cartridge body 2 as a whole can be made sufficiently higher than that of the cartridge case 12 of the conventional disc recording medium device 10. For this reason, when the disc cartridge 1 is placed in a bag or the like and carried, even if an external force that tries to bend the cartridge body 2 is applied, deformation (bending) of the cartridge body 2 is avoided and the occurrence of recording/reproducing errors inside a recording/reproducing apparatus is avoided. Also, since the reinforcing member 7 formed of stainless steel is quite thin, the rigidity of the cartridge body 2 is increased without making the overall thickness of the cartridge body 2 much larger. In addition, by setting the inner diameter of the brim part 32 of the reinforcing member 7 larger than the diameter of the optical disc 10, contact between the reinforcing member 7 and the optical disc 10 inside the cartridge body 2 is avoided and the optical disc 10 is prevented from becoming less visible through the upper shell 4 due to the presence of the reinforcing member 7.

In this way, according to the disc cartridge 1, by fixing the reinforcing member 7 formed separately to the upper shell 4 to the inner surface of the upper shell 4 so as to cross the opening 3a of the lower shell 3 in a state where the lower shell 3 is fitted to the upper shell 4, it is possible to provide a disc cartridge 1 with the cartridge body 2 that has high rigidity to adequately avoid damage to the cartridge body 2 itself and the optical disc 10 and the occurrence of recording/reproducing errors when an external force is applied (when the cartridge body 2 is bent, for example), while making it possible to carry out recording and reproducing on the optical disc 10 using two optical heads simultaneously. Here, by using a construction where the reinforcing member 7 formed separately to the upper shell 4 is fixed to the top plate 22a, it is possible for example to form the upper shell 4 using a transparent resin material (in this example, polycarbonate) and to form the reinforcing member 7 out of a highly rigid member (in this example, stainless steel) that resists bending and the like and fix the reinforcing member 7 to the upper shell 4, and therefore it is possible to use a variety of designs where the optical disc 10 is kept sufficiently visible through the upper shell 4 while increasing the rigidity of the cartridge body 2.

According to the disc cartridge 1, by using the reinforcing member 7 formed in an annular shape where the inner diameter is larger than the diameter of the optical disc 10, it is possible to increase the rigidity while keeping the optical disc 10 favorably visible through the upper shell 4 and without making the appearance less attractive.

In addition, according to the disc cartridge 1, by forming the reinforcing member 7 of metal (in this example, stainless steel), unlike a construction where rigidity is increased by molding the upper shell itself from a glass fiber-including resin or the like, it is possible to increase the rigidity without the optical disc 10 becoming less visible through the upper shell 4 and it is possible to use a variety of designs and thereby make the cartridge body more attractive. Also, unlike a construction that increases the rigidity of the entire cartridge body by making the upper shell thicker to increase the rigidity of the upper shell as a single body, it is possible to provide the disc cartridge 1 including the cartridge body 2 that has sufficient rigidity to avoid damage to the cartridge body 2 itself and the optical disc 10 and recording/reproducing errors without making the overall thickness of the cartridge body much thicker (i.e., while satisfying the standards concerning size that are set for the disc cartridge 1).

Note that the present invention is not limited to the construction described above. For example, the disc-shaped recording medium for the present invention is not limited to the rewritable optical disc 10 described above, and includes not only various types of optical disc such as a read-only optical disc and a write-once optical disc but also a magneto-optical disc and a magnetic disc. In addition, although the reinforcing member 7 is formed of stainless steel in the above construction, the material of the reinforcing member for the present invention is not limited to such and it is possible to use fiber-reinforced resin such as glass fiber-including resin and carbon fiber-including resin, and various metal materials aside from stainless steel. In this case, since a construction where fiber-reinforced resin is used is light compared to a metal material such as stainless steel, the rigidity of the cartridge body can be increased while reducing the overall empty weight of the disc cartridge 1.

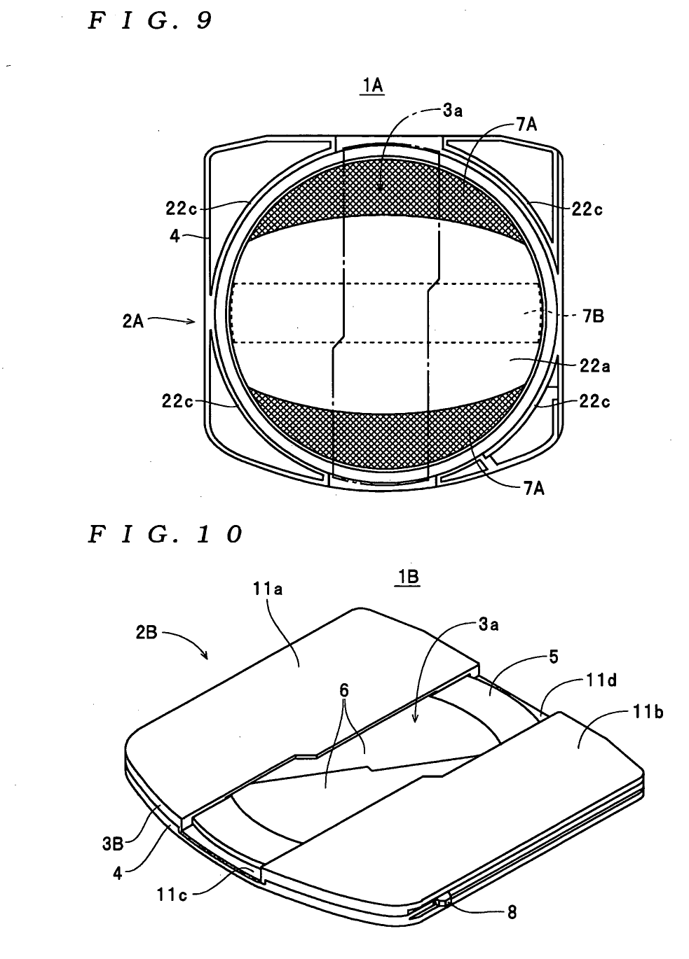

Also, although the disc cartridge 1 described above uses a construction where the reinforcing member 7 formed in an annular shape with an inner diameter that is larger than the diameter of the optical disc 10 is fixed to the inner surface (the top plate 22a) of the upper shell 4, the present invention is not limited to such. For example, like a disc cartridge 1A shown in FIG. 9, it is possible to use a construction where reinforcing members 7A, 7A in the form of crescent moons whose external forms extend in the left-right direction (a direction perpendicular to the loading and ejecting direction in a recording/reproducing apparatus) of the cartridge body 2 are stuck (to the inner surface of the top plate 22a) inside of the partition wall 22c of the upper shell 4 so as to cross the opening 3a of the lower shell 3 (not shown) in a state where the lower shell 3 is fitted to the upper shell 4). With this construction, it is possible to increase the rigidity of the cartridge body 2A and avoid damage to the optical disc 10 using the reinforcing members 7A, 7A in the same way as the disc cartridge 1 described above, while keeping the optical disc 10 sufficiently visible through the upper shell 4 at a central part of the upper shell 4 (i.e., between the reinforcing members 7A, 7A). Note that the outline forms of the reinforcing members 7A, 7A are not limited to a crescent moon shape, and attachment positions of the reinforcing members 7A may also be set as appropriate. For example, as shown by the broken lines in FIG. 9, it is possible to use a construction where a reinforcing member 7B, whose external form is rectangular and extends in the left-right direction of the cartridge body 2 so as to cross the opening 3a of the lower shell 3 (not shown), is attached inside the partition wall 22c of the upper shell 4 (to a central position on an inner surface of the top plate 22a).

In addition, although in the disc cartridge 1 described above, the cartridge body 2 includes the lower shell 3 including the separate and independent lower shell bodies 11a and 11b, the present invention is not limited to this, and like a disc cartridge 1B shown in FIG. 10, for example, it is possible to construct a cartridge body 2B using a lower shell 3B where the lower shell bodies 11a and 11b are integrally linked by linking parts 11c, 11d. In addition, the shape of the disc access opening for the present invention is not limited to a rectangular shape that extends in the front-rear direction of the cartridge body as in the example described above, and may be a rectangular shape that extends in the left-right direction of the cartridge body or a rectangular shape that extends in a diagonal direction for a square cartridge body.

### INDUSTRIAL APPLICABILITY

As described above, with the disc cartridge according to the present invention, by fixing a reinforcing member formed separately to the upper shell to an inner surface of the upper shell so as to cross the disc access opening of the lower shell in a state where the lower shell is fitted to the upper shell, it is possible to realize a disc cartridge including a cartridge body with high rigidity to adequately avoid damage to the cartridge body itself and the disc-shaped recording medium and the occurrence of recording/reproducing errors when an external force is applied (when the cartridge body is bent, for example) while allowing recording and reproducing to be carried out on a disc-shaped recording medium using two optical heads simultaneously.

### DESCRIPTION OF REFERENCE NUMERALS

1, 1A, 1B: Disc cartridge

2, 2A, 2B: Cartridge body

3, 3B: Lower shell

3a: Opening

4: Upper shell

5: Disc tray

6: Shutter member

7, 7A, 7B: Reinforcing member

10: Optical disc

10a: Center hole

11a, 11b: Lower shell body

11c, 11d: linking part

12a: Base plate

12a, 22b: Side wall

12c, 22c: Partition wall

13, 43: Convex parts

22a: Top plate

31: Cylindrical part

32: Brim part

A: Region

1. A disc cartridge where a disc-shaped recording medium is housed in a cartridge body including a lower shell and an upper shell formed so as to be capable of being fitted together,
wherein a disc access opening, which is capable of exposing a region that extends from one outer edge part to another outer edge part on an opposite side of a center hole of the disc-shaped recording medium housed inside the cartridge body, is formed in the lower shell, and
a reinforcing member formed separately to the upper shell is fixed to an inner surface of the upper shell so as to cross the disc access opening in the lower shell in a state where the lower shell is fitted to the upper shell.

2. A disc cartridge according to claim 1, wherein the reinforcing member is formed in an annular shape with an inner diameter that is larger than a diameter of the disc-shaped recording medium.

3. A disc cartridge according to claim 1, wherein the reinforcing member is formed of one of fiber-reinforced resin and metal.

4. A disc cartridge according to claim 2, wherein the reinforcing member is formed of one of fiber-reinforced resin and metal.
